(19) United States
(12) Patent Application Publication
(10) Pub. No.: US 2004/0002400 A1
(43) Pub. Date: Jan. 1, 2004

(54) Belt installation tool

(76) Inventors: John Ellis, Rochester Hills, MI (US); Barry Fletcher, Belle River (CA); John Martin Shaw, White Lake, MI (US)

Correspondence Address: Jeffrey Thurnau, The Gates Corporation, Mail Stop 31-4-1-A3, 900 S. Broadway, Denver, CO, 80209, US

(21) Appl. No.: 10/437,803

(22) Filed: May 14, 2003

Related U.S. Application Data
(60) Provisional application No. 60/392,886, filed on Jun. 28, 2002.

(51) Int. Cl. F16H 7/22

(52) U.S. Cl. 474/130

(57) ABSTRACT

A belt installation tool having a substantially planar body having a circumferential surface and a roller. The roller radially projects from the body. An axis of rotation of the roller is disposed cooperatively with a belt urging member. The belt urging member projects from an outer flange. The roller urges a belt slightly radially outward from a pulley center. The belt urging member then urges the belt laterally to install the belt in a pulley groove. A second roller projecting radially from the body and having an axis of rotation parallel to the body is used to remove a belt from a pulley.

### REFERENCE TO RELATED APPLICATIONS

This application claims priority from U.S. Provisional patent application serial No. 60/392,886 filed Jun. 28, 2002.

### FIELD OF THE INVENTION

The invention relates to a belt installation tool and more particularly to a belt installation tool having a roller cooperatively aligned with an urging member for radially extending and laterally moving a belt during installation or removal.

### BACKGROUND OF THE INVENTION

Belt drive systems comprise a significant and widely used form of mechanical power transmission. Generally a belt runs between two or more pulleys, more particularly a driver and driven pulley.

In order to efficiently transmit power between the pulleys the belt is installed with a predetermined pre load or tension. The amount of tension is generally a function of the horsepower and torque requirements of the drive. An increased horsepower or torque requirement will generally require a commensurate increase in the tension of the belt.

In order to achieve the proper tension, one or more of the pulleys is loosened so the shaft or shafts can be moved to allow a slack condition in the belt. Then, the belt is looped over the pulleys. The loosened pulley or pulleys are then pulled or tightened in a predetermined position, resulting in a tension in the belt. This process requires the pulley(s) to be mechanically adjusted to properly tension the belt.

Belts may be installed on pulley systems using other methods. For systems with an automatic tensioning device the tensioner is loaded, the belt is placed in an operating position, and the tensioner is released to its operational location. For systems without a tensioner, belts are wrapped around the pulleys and then a pulley is tightened to its final location by a bracket or similar devices.

Another method of installing a belt involves use of a tool that presses the belt into a pulley groove without the need for mechanically adjusting the pulleys. The tool is used adjacent to a pulley. It stretches the belt while laterally forcing it into a pulley groove.

Representative of the prior art is European Patent No. 0 831 247 B1 to Hutchinson which discloses a tool having a radial thrust area resting against a girth of the pulley, keeping a belt away from a pulley until it reaches a plane spaced from a pulley surface.

Also representative of the art is U.S. Pat. No. 4,193,310 (1980) to Boyer et al. which discloses a pulley having a diverging means extending radially and laterally from the rim for engaging and seating the belt on the pulley rim.

The prior art tools do not comprise a roller for radially extending a belt during installation. Nor do the prior art tools allow a belt to be installed without rotating a pulley.

What is needed is a belt installation tool having a roller for radially urging a belt during installation or removal. What is needed is a belt installation tool having a roller cooperatively aligned with an urging member for laterally moving a belt into a pulley groove. The present invention meets these needs.

### SUMMARY OF THE INVENTION

The primary aspect of the invention is to provide a belt installation tool having a roller for radially urging a belt during installation or removal.

Another aspect of the invention is to provide a belt installation tool having a roller cooperatively aligned with an urging member for laterally moving a belt into a pulley groove.

Other aspects of the invention will be pointed out or made obvious by the following description of the invention and the accompanying drawings.

A belt installation tool having a substantially planar body having a circumferential surface and a roller. The roller radially projects from the body. An axis of rotation of the roller is disposed cooperatively with a belt urging member. The belt urging member projects from an outer flange. The roller urges a belt slightly radially outward from a pulley center. The belt urging member then urges the belt laterally to install the belt in a pulley groove. A second roller projecting radially from the body and having an axis of rotation parallel to the body is used to remove a belt from a pulley.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a front view of the tool.

FIG. 2 is a side view of the tool.

FIG. 3 is a cross-sectional view of the tool at line 33 in FIG. 1.

FIG. 4 is a side view of the tool.

FIG. 5 is a detail of FIG. 1.

FIG. 6 is a top view of a roller assembly.

FIG. 7 is a side view of a roller assembly.

FIG. 8 is a front view of a roller assembly.

FIG. 9 is a perspective view of the tool.

FIG. 10 is a front view of the tool in use on an engine.

### DETAILED DESCRIPTION OF THE PREFERRED EMBODIMENT

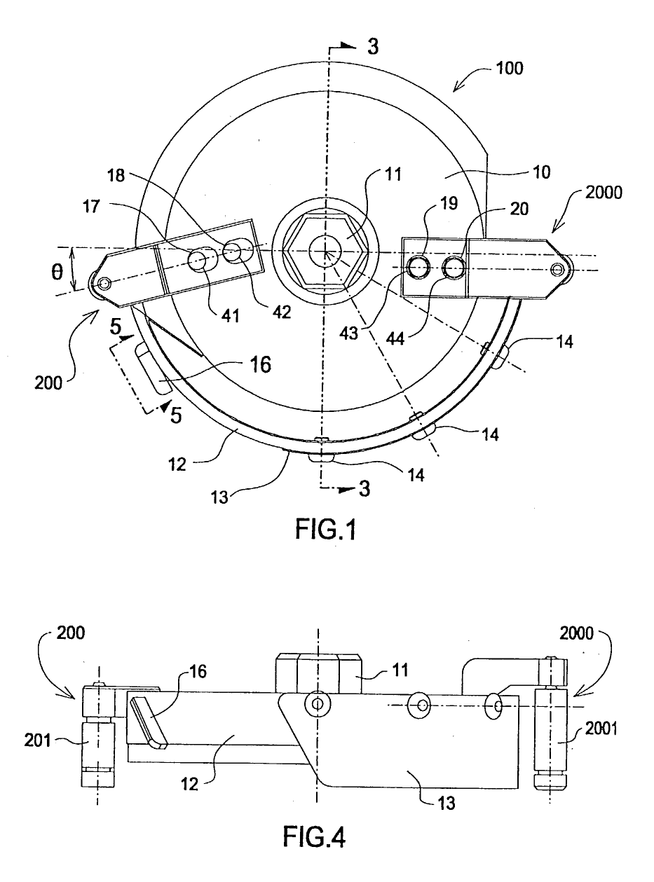

FIG. 1 is a front view of the tool. Tool 100 comprises a body 10 having a hub 11 and circumferential outer flange portion 12. Hub 11 describes a hexagonal form that is engaged by a handtool, such as a box end or open end wrench, ratchet tool, or impact wrench and the like during use. Tool 100 may comprise a metallic substance or any other suitably rigid non-metallic material, such as plastic, ceramic or phenolic.

Flange 12 comprises a surface extending about a portion of an outer circumference of the tool. Member 13 is substantially flat and has an arcuate shape. Member 13 is fastened to flange 12 with fasteners 14. Fasteners 14 may comprise any known means to attach member 13 to surface 12 such as rivets, screws, or tack welds. Member 13 comprises material that is flexible to allow some slight deformation as a belt slides over it toward a pulley groove. Member 13 may also be formed integrally with surface 12 during a manufacturing process, in which case no fasteners 14 are necessary.

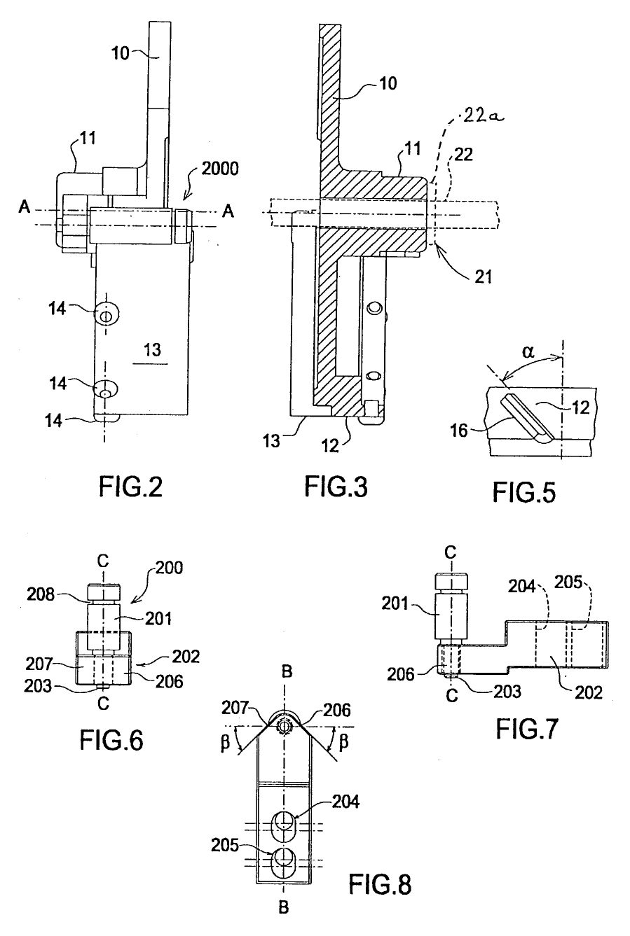

Belt urging member 16 is attached to flange 12. Member 16 radially projects from flange 12 and is disposed at approximately a 45° angle to a tool major axis A-A, see FIG. 2. Member 16 urges a belt laterally toward a pulley groove.

Roller assemblies 200 and 2000 are shown connected to tool 100 by fasteners 41, 42, 43, 44. Fasteners 41, 42, 43, 44 comprise threaded fasteners but may also comprise any other suitable fastener known in the art. Fasteners 41, 42 engaged with holes 17, 18 to connect roller assembly 200 to tool 100. Fasteners 43, 44 engaged with holes 19, 20 to connect roller assembly 2000 to tool 100. Depending upon the mode of use as further described herein, tool 100 may be use with either roller assembly 200 or 2000 or with both roller assemblies.

Roller assembly 200 may be oriented at an angle θ to a radial to facilitate a belt installation. Angle θ may be in the range of approximately 0° to 45°. Roller assembly 2000 may be oriented parallel to a radial on the tool as shown, or at an angle.

Although two roller assemblies 200 and 2000 are shown in FIG. 1, tool 100 may also be configured with a single roller assembly 200 as well. Roller assembly 200 is used to install a belt on a pulley while roller assembly 2000 may be used to remove a belt from a pulley.

FIG. 2 is a side view of the tool. Hub 11 projects parallel to a major axis A-A from tool body 10. Fasteners 14 attach member 13 to outer flange 12. Tool 100 rotates about an axis A-A when in use.

FIG. 3 is a cross-sectional view of the tool at line 3-3 in FIG. 1. Bore 21 extends through hub 11 and receives member 22 for engaging the tool to a drive shaft or pulley. Member 22 and head 22a may comprise a threaded rod or fastener. Tool 100 rotates about member 22 during use.

To install a belt, member 22 is threadably engaged to a shaft or pulley (see FIG. 10). Fastener 22 and fastener head 22a thereby rotatably retain tool 100 in a proper position with respect to a pulley, see FIG. 10. A handtool, such as a wrench for example, is then engaged with the hexagonal form of hub 11. A belt is partially started into a pulley groove. Tool 100 is turned in direction R using the handtool thereby engaging roller 201 with a belt surface. Roller 201 partially radially extends a belt in order for the belt to clear a pulley rim. The tool is further turned whereby a belt side surface is brought into engagement with the belt urging member 16. Upon further turning, roller 201 radially displaces the belt slightly beyond a pulley edge as member 16 continues to laterally urge the belt toward and into a pulley groove. The belt slides upon flange 12 and member 13 in order to assure proper alignment before fully engaging a pulley groove as the tool is turned. Once the belt is installed, member 22 and tool 100 are removed from the pulley.

To remove a belt from a pulley, the tool is connected to the shaft or pulley as previously described. Member 13 slidingly comes into contact with a belt surface. The tool is turned using a handtool until roller 2001 engages the belt surface between the belt and a pulley. Roller 2001 radially urges a belt out of a pulley groove. The tool is progressively turned while the belt is laterally diverted from the pulley groove by a lateral pressure applied by a user. The tool is turned until the belt is fully disengaged from the pulley groove. The tool is then removed as previously described.

Unlike the prior art, the instant invention allows a belt to be installed upon a pulley without the need to rotate the pulley, instead, the tool rotates about member 22. The tool allows a belt to be installed without turning the pulley, which, for example, eliminates the risk of damaging a bearing by turning a pulley and an attached shaft without the engine lubrication system being in operation.

FIG. 4 is a side view of the tool. Belt urging member 16 is attached to and projects from flange 12. Member 13 is attached to flange 12 with fasteners 14. Roller assemblies 200 and 2000 extend radially beyond the flange 12 and member 13 of the tool. When the tool is used to install a belt roller assembly 2000 is not present.

FIG. 5 is a detail of FIG. 1. Member 16 is shown disposed at approximately a 45° angle α to a tool major axis A-A. Angle α may be in the range of approximately 30° to 60°.

FIG. 6 is a top view of a roller assembly. Roller assembly 200 comprises roller 201 rotatably connected to body 202 by shaft 203. Roller assembly 200 is a means for radially urging a belt radially outward from a pulley in order to facilitate a belt installation.

Roller 201 rotates about shaft 203 about an axis of rotation C-C. Roller 201 may be connected to the body such that an axis of rotation C-C is aligned to cooperate with belt urging member 16. For example, if member 16 is disposed at an angle of approximately 45° to a tool axis of rotation A-A, then the roller axis of rotation C-C may be cooperatively disposed approximately normally to member 16 in order to facilitate installation of a belt. Of course, roller 201 may also be disposed to member 16 as shown in FIG. 1 with equal ease of use. Roller 201 also may comprise a groove 208. Groove 208 engages a belt rib in order to guide the belt toward member 16.

FIG. 7 is a side view of a roller assembly. Holes 204 and 205 receive fasteners 41, 42.

FIG. 8 is a front view of a roller assembly. Surface 206 and surface 207 each are disposed at an approximate 45° angle β to a roller assembly major axis B-B. The angle at which surface 206, 207 are disposed allows a belt to easily approach and engage roller assembly 200 as it progress over the roller 201 and into a pulley groove. Angle θ can be in the range of approximately 30° to 60°.

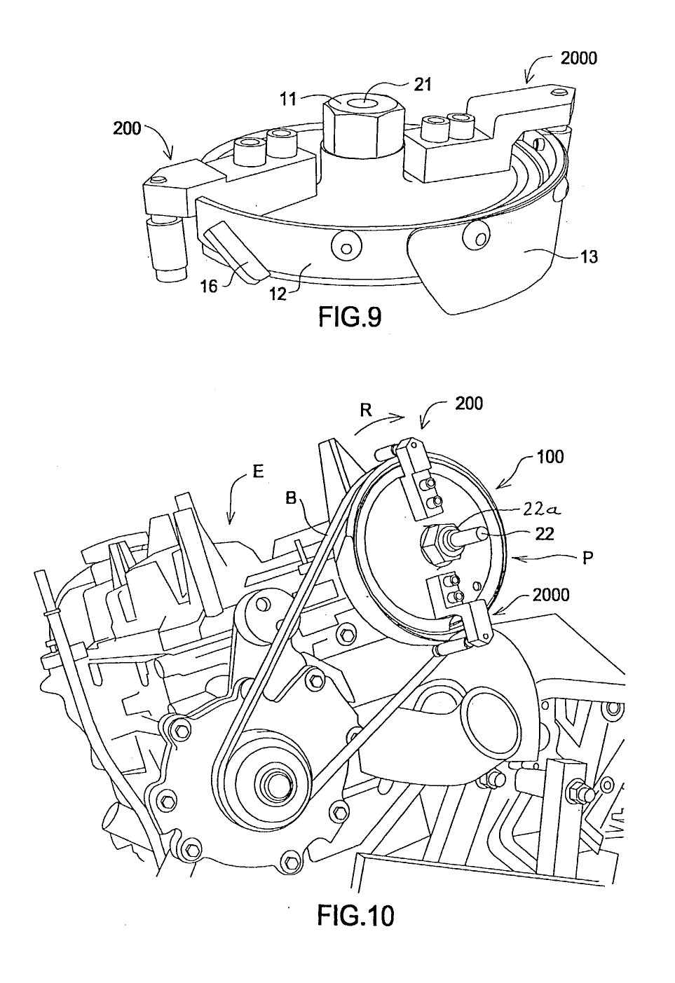

FIG. 9 is a perspective view of the tool. Roller assembly 200 and roller assembly 2000 are shown installed on tool 100. Roller assembly 200 is used to install a belt. Roller assembly 2000 is used to remove a belt from a pulley. Each of roller assembly 200 and 2000 are fastened to the tool using threaded fasteners, for example, and are therefore removable from the tool. Since each roller assembly is removable, tool 100 may be used with only roller assembly 200 or only with roller assembly 2000, although both are depicted in FIGS. 1, 4, 9 and 10.

FIG. 10 is a front view of the tool in use on an engine. Engine E may comprise a pulley P and a belt B. Fastener 22 is used to engage tool 100 with a pulley P. To install a belt tool 100 rotates in direction R about fastener 22, which is rotatably connected to pulley P. For the purpose of description, tool 100 is shown with roller assembly 200 and 2000, although it can be used with only roller assembly 200 or with only roller assembly 2000 as well.

Although a single form of the invention has been described herein, it will be obvious to those skilled in the art that variations may be made in the construction and relation of parts without departing from the spirit and scope of the invention described herein.

I claim:

1. A tool comprising:
a body having an axis of rotation;
an urging member connected to an outer circumferential portion of the body, the urging member disposed with respect to the body axis of rotation to laterally urge a belt into a pulley; and
a roller extending radially beyond the outer portion of the body, the roller having an axis of rotation parallel with the body axis of rotation and disposed to facilitate a belt movement over the roller toward the urging member.

2. The tool as in claim 1 further comprising:
a hub having a tool engaging surface.

3. The tool as in claim 2 further comprising;
a fastener for connecting the tool to a pulley.

4. The tool as in claim 2 further comprising:
a surface disposed on the circumferential outer portion of the body for slidingly engaging a belt.

5. The tool as in claim 4 further comprising:
a second roller extending radially beyond the outer portion of the body, the second roller having an axis of rotation parallel with the body axis of rotation, the second roller for engaging a belt for removal from a pulley; and
the second roller cooperatively disposed with the surface to remove a belt from a pulley.

6. A tool comprising;
a body having an outer circumferential surface and an axis of rotation;
a first roller and a second roller rotatably connected to the body, an axis of rotation of the first roller and second roller parallel to the body axis of rotation;
an urging member attached to the outer circumferential surface for laterally urging a belt into a pulley groove, the urging member cooperatively disposed with the first roller; and
a surface attached to the outer circumferential surface for slidingly engaging a belt, the surface cooperatively disposed with the second roller.

7. The tool as in claim 6 further comprising;
a hub connected to the body for engaging a handtool.

8. A tool comprising;
a body having an axis of rotation;
a roller means extending radially from the body and having an axis of rotation parallel to the body axis of rotation, the roller means for engaging a belt; and
a surface on the body cooperatively disposed with the roller for slidingly engaging the belt as the tool is rotated.

9. The tool as in claim 8 further comprising:
a second roller means extending radially from the body and having an axis of rotation parallel to the body axis of rotation;
an urging member attached to a body outer surface for laterally urging the belt, the urging member cooperatively disposed with the second roller.

10. The tool as in claim 8 further comprising a hub for engaging a handtool.

11. The tool as in claim 9 further comprising a hub for engaging a handtool.
